(19) United States
(12) Patent Application Publication
(10) Pub. No.: US 2026/0119493 A1
(43) Pub. Date: Apr. 30, 2026

(54) PARALLEL PRUNING AND BATCH SORTING FOR SIMILARITY SEARCH ACCELERATORS

(71) Applicant: Intel Corporation, Santa Clara, CA (US)

(72) Inventors: Srajudheen MAKKADAYIL, Bangalore (IN); Somnath PAUL, Hillsboro, OR (US); Shabbir Abbasali SAIFEE, Bangalore (IN); Bakshree MISHRA, Odisha (IN); Vidhya THYAGARAJAN, Pleasanton, CA (US); Manoj VELAYUDHA, Bangalore (IN); Muhammad KHELLAH, Tigard, OR (US); Aniekeme UDOFIA, Chandler, AZ (US)

(73) Assignee: Intel Corporation, Santa Clara, CA (US)

(21) Appl. No.: 19/433,775

(22) Filed: Dec. 27, 2025

Related U.S. Application Data
(63) Continuation of application No. 17/358,495, filed on Jun. 25, 2021.

(51) Int. Cl. G06F 16/2453; G06F 16/22

(52) U.S. Cl. CPC G06F 16/24542; G06F 16/2237; G06F 16/24532

(57) ABSTRACT

Systems, apparatuses and methods include technology that determines, with a first processing engine of a plurality of processing engines, a first partial similarity measurement based on a first portion of a query vector and a first portion of a first candidate vector. The technology determines, with a second processing engine of the plurality of processing engines, a total similarity measurement based on the query vector and a second candidate vector. The technology determines, with the first processing engine, whether to compare a second portion of the query vector to a second portion of the first candidate vector based on the first partial similarity measurement and the total similarity measurement.

### TECHNICAL FIELD

Embodiments generally relate to processing architectures that execute parallel pruning and similarity computations for candidate vectors and query vectors with similarity processing engines. Embodiments include a shared heap hardware that sorts results from the parallel similarity processing engines.

### BACKGROUND

Content-based similarity search (e.g., a similarity search) may be fulfilled by machine learning (ML) and/or artificial intelligence (AI) applications (e.g., recommendation engines, visual search engine, drug discovery, etc.). For example, a database may include a large number (e.g., billions) of high-dimensional candidate vectors. A query vector q of the same dimension, format and size (e.g., 512 bytes) may be matched (e.g., based on some similarity function such as Euclidean similarity measurement) against the database to identify database vectors that are similar and/or closest to query vector q. For example, a content-based image retrieval (CBIR) system may identify similar images in a database using a query image that is decomposed into a query vector and then matched against candidate vectors representing the similar images. The feature extraction step may involve a deep learning model. Moreover, in modern applications, these vectors may represent a wide array of categories, such as the content of images, text, web searches, protein sequencing, faces, sounds, or bioinformatic data that are extracted and summarized by deep learning systems.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram of an example of a near memory similarity search architecture according to an embodiment;

FIGS. 2A-2B is a diagram of an example of an architecture for far-memory similarity search matching according to an embodiment;

FIG. 3 is a flowchart of an example of a method of similarity search processing with pruning according to an embodiment;

FIG. 4 is a timing diagram of an example of similarity searching with processing engines according to an embodiment;

FIG. 5 is a flowchart of an example of a method of query streaming according to an embodiment;

FIG. 6 is a flowchart of an example of a method of similarity computation according to an embodiment;

FIG. 7 is a diagram of an example of a heap memory structure according to an embodiment;

FIG. 8 is a flowchart of an example of a method of inserting a new node entry into an unfilled heap memory structure according to an embodiment;

FIG. 9 is a flowchart of an example of a method inserting a new node entry into a filled heap memory structure according to an embodiment;

FIG. 10 is a block diagram of an example of a similarity-search enhanced computing system according to an embodiment;

FIG. 11 is an illustration of an example of a semiconductor apparatus according to an embodiment;

FIG. 12 is a block diagram of an example of a processor according to an embodiment; and

FIG. 13 is a block diagram of an example of a multi-processor based computing system according to an embodiment.

### DESCRIPTION OF EMBODIMENTS

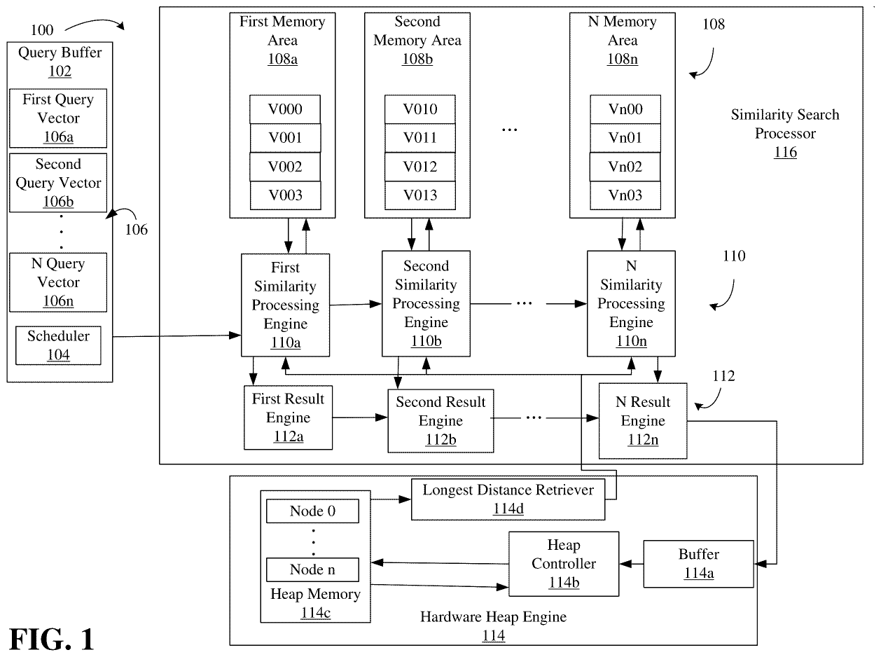

Turning now to FIG. 1, a similarity search architecture 100 (e.g., a system-on-chip) implements an enhanced similarity and early pruning search process that executes with reduced latency, less bandwidth and reduced computational resources. In detail, the similarity search architecture 100 executes parallel similarity computations with an array of similarity processing engines (PEs) 110 (e.g., configurable logic, fixed-functionality logic hardware, processing elements, execution units, etc.) to identify closest similarity matches between first-N query vectors 106a-106n and candidate vectors V000-Vn03. As will be explained in further detail, the similarity PEs 110 execute early pruning (e.g., bypassing) to discard similarity processing at early stages to reduce computing resources and processing power. Furthermore, the similarity PEs 110 operate with a near memory architecture comprising the memory areas 108 to reduce bandwidth and communication latency. Moreover, the architecture 100 may operate over a batch of query vectors 106 while the candidate vectors V000-Vn03 are stored in memory areas 108 to avoid high latency data retrieval of the candidate vectors V000-Vn03 from long-term storage.

In detail, the similarity PEs 110 may determine various similarity measurements (e.g., Manhattan distance, Euclidean distance, Minkowski and Hamming distance, Cosine and/or Inner-Product similarity). A degree of similarity may be determined by a distance metric such as Manhattan distance, Euclidean distance, Minkowski and Hamming distance, such a lower the distance corresponds to a higher similarity. In some examples, the PEs 110 may prune (e.g., bypass) future similarity computations (e.g., similarity measurements) between a respective vector candidate of the candidate vectors V000-Vn03 and a respective query vector of the query vectors 106 when a partially calculated distance therebetween is more than a threshold (e.g., a longest distance as determined from a top k distances, and/or a lowest similarity score). Such pruning occurs at an early stage prior to determining all similarity measurements between vector features of the respective candidate vector and the respective query vector to determine whether to ignore the respective candidate vector. Doing so may reduce computational resources and latency without reducing accuracy. While each of the memory areas 108 includes four vectors of the candidate vectors V000-Vn03, it will be understood that such a number is exemplary, and embodiments as described herein are not so limited. Indeed, each of the memory areas 108 may store any number (e.g., M number) of candidate vectors and operate similarly to as described herein.

Furthermore, some embodiments include first-N memory areas 108a-108n (e.g., static random-access memory banks) that each store a subset of the candidate vectors V000-Vn03 and are each dedicated to one of the similarity PEs 110. The similarity PEs 110 may efficiently execute in parallel and based on different candidate vectors of the candidate vectors V000-Vn03 retrieved from the first-N memory areas 108a-108n. Doing so may further reduce latency since each of the first-N similarity PEs 110a-110n may have less idling and waiting due to blocks and waiting for computations of other similarity PEs 110a-110n. For example, each of the first-N similarity PEs 110a-110n may operate independently of the other first-N similarity PEs 110a-110n to execute similarity searching on a subset of the candidate vectors V000-Vn03.

Moreover, the first-N similarity PEs 110a-110n may process a batch of first-N query vectors 106a-106n in serial. Doing so may reduce memory fetches and power consumption since the candidate vectors V000-Vn03 may remain in the first-N memory areas 108a-108n throughout processing of the first-N query vectors 106a-106n. For example, the similarity PEs 110 may access a continuous query stream of query vectors 106 to execute similarity searches.

As described herein, a feature may be a piece of useful extracted information from data. A size of feature may be in bytes (e.g., 1 byte) and also be referred to as dimension. A high dimensional input, such as an image, may be reduced to a reduced number of dimensions or features. A vector (such as a query vector and/or candidate vector) includes multiple features to form a feature vector. A size of the feature vector is determined by a number of features and size of each feature (e.g., one byte, INT8 format size, INT16 format size, INT32 format size, FP32 format size, BF16 format size). A query (or query vector) may be a feature vector extracted from an on-going application or user search. For example, if a face detection application is utilized, the query vector would be the feature vector extracted from a query face, and the query vector may be compared against candidate vectors (that each represent a candidate face) to identify a matching face.

In embodiments, the similarity PEs 110 determine distances which represent a degree of similarity between two vectors (e.g., quantifies the similarity between the two vectors). That is, the similarity PEs 110 calculate the distance or similarity between a respective query vector of the query vectors 106 and a respective candidate vector of the candidate vectors V000-Vn03 at a given point of time. For example, a single similarity PE of the similarity PEs 110 may execute over a number (e.g., 512) of clock cycles to compare the respective query vector against the respective candidate vector assuming a corresponding feature size (e.g., 512 bytes if the data path is 1 byte wide).

As described, the similarity PEs 110 determine distances as similarity measurements. It will be understood that embodiments as described herein may determine other similarity measurements, and operate similarly to as described herein with respect to distances. Thus, the architecture 100 utilizes the mathematical property of distance and similarity algorithms to cyclically compute similarity over features in query vectors 106 and candidate vectors V000-Vn03.

Moreover, embodiments implement a heap hardware engine 114 that efficiently sorts results from the parallel first-N similarity PEs 110a-110n. The heap hardware engine 114 enables batch sorting with an apparatus for a hardware friendly implementation of heap algorithms to handle multiple parallel queries and entries.

As illustrated, the query buffer 102 contains first-N queries 106a-106n. Query buffer 102 includes a scheduler 104 (e.g., a finite state machine) that schedules a query of the first-N query vectors 106a-106n being streamed to the similarity PEs 110. The query buffer 102 stores a set of query vectors 106 (e.g., queries). It is possible to compare an entire candidate vector database against the query vectors 106 one after the other.

The similarity search processor 116 (e.g., a specialized processor and/or accelerator architecture) receives one query vector of the first-N query vectors 106a-106n at a time to execute similarity search processing. After the one query vector has completed processing, the similarity search processor 116 receives another query of the first-N query vectors 106a-106n to execute similarity search processing. As will be described below, the similarity search processor 116 stores the vector database and matches the vector database against the first-N query vectors 106a-106n. The vector database may be a large collection of feature vectors (e.g., a face database includes feature vector extracted from each face of a large population). The feature vectors of the vector database are candidate vectors V000-Vn03. The similarity search processor 116 may match the first-N query vectors 106a-106n (e.g., query faces) against the candidate vectors V000-Vn03 (e.g., faces) to identify most similar matches (e.g., identify matches between faces).

The similarity search processor 116 includes the memory areas 108 (e.g., memory banks). In this example, the similarity search processor 116 may execute a near memory compute with the similarity PEs 110 which operate in parallel. For example, a vector database, including the candidate vectors V000-Vn03, may be stored in the storage areas 108. The candidate vectors V000-Vn03 may be of a size that is able to fit within the memory areas 108, therefore enabling all of the candidate vectors V000-Vn03 to be efficiently contained in the memory areas 108 (e.g., on-board memory). Thus, each of first-N memory areas 108a-108n stores ‘a’ number of vectors from the vector database. Thus, the first-N similarity PEs 110a-110n access ‘a*N’ number of candidate vectors V000-Vn03, where N is a total number of the first-N memory areas 108a-108n.

As illustrated, each of the first-N memory areas 108a-108n is connected to one of the first-N similarity PEs 110a-110n. For example, the first memory area 108a is connected with and dedicated to the first similarity PE 110a, the second memory area 108b is connected with and dedicated to the second similarity PE 110b, and so on with the N memory area 108n being connected with and dedicated to the N similarity PE 110n. For example, the first similarity PE 110a is prevented and/or inhibited from accessing the second-N memory areas 108b-108n that are dedicated to other PEs of the second-N similarity PEs 110b-110n. Thus, each of the first-N similarity PEs 110a-110n only has access to and operates on a subset of the candidate vectors V000-Vn03.

The scheduler 104 streams the queries 106 to the similarity PEs 110 in a daisy-chain fashion. For example, the scheduler 104 may stream the first query vector 106a to the first similarity PE 110a (which may occur over several clock cycles). The first similarity PE 110a may receive the first query vector 106a and in turn, provide the first query vector 106a to the second similarity PE 110b over one or more clock cycles, and so on until the N similarity PE 110n receives the first query vector 106a from a preceding similarity PE of the similarity PEs 110.

The first similarity PE 110a may begin a similarity search when the first query vector 106a is received. For example, the first similarity PE 110a may compare the first query vector 106a to the candidate vector V000 to determine a degree of similarity between the first query vector 106a and the candidate vector V000. As noted, the degree of similarity may be determined by a distance metric such as Manhattan distance, Euclidean distance, Minkowski and Hamming distance, such that lower the distance, the higher the similarity. Each of the first-N similarity PEs 110a-110n may execute similar computations for similarity once the first query vector 106a is received. For example, the second similarity PE 110b may generate a distance between the first query vector 106a and the candidate vector V010, the N similarity PE 110n may generate a distance between the first query vector 106a and the candidate vector Vn00 and so forth.

Once a total distance is calculated, the total distance may be transmitted to the hardware heap engine 114 if the total distance is smaller than the longest distance (described further below), and through results engines 112 that are daisy-chained together. For example, after that the first similarity PE 110a calculates a total distance between the vector V000 and the first query vector 106a, the first similarity PE 110a transmits the total distance to a first result engine 112a in association with a vector ID of the vector V000. The vector ID (not the entire vector V000) is transmitted to reduce bandwidth and facilitate identification at a later time. The first result engine 112a transmits the vector ID and total distance to the second result engine 112b, which in turns transmits the vector ID and total distance to a following result engine of the result engines 112 until the N result engine 112n is reached. The N result engine 112n transmits the vector ID and the total distance to a buffer 114a (e.g., an elastic buffer) which may temporarily store the vector ID and the total distance until the heap controller 114b is available. The heap controller 114b may receive the vector ID and the total distance when the heap controller 114b is available. The heap controller 114b stores the vector ID and the total distance in one of the nodes 0-n (any number of nodes may be used) of a heap memory 114c.

The nodes 0-n may be arranged as a tree data structure in some examples. For example, the heap memory 114c may store nodes 0-n as binary tree data structure that holds the maximal (e.g., a max-heap binary tree)/minimal element (e.g., min-heap binary tree) in the tree in the root. The configuration of the binary data tree structure may be set as maximal or minimal based on the distance or similarity metric selection. Considering that a maximal data structure is chosen, the longest distance in the present example is stored in the root. The longest distance retriever 114d may retrieve and select the longest distance from the nodes 0-n. The longest distance retriever 114d provides the longest distance to the first-N similarity PEs 110a-110n. The longest distance may be a lowest similarity score (longest distance) from all similarity scores (distances) stored in the heap memory 114c.

Each distance in the heap memory 114c reflects a degree of similarity between one of the candidate vectors V000-Vn03 and the first query vector 106a. In this example, a greater degree of similarity corresponds to a shorter distance, while a lower degree of similarity corresponds to a longer distance. The longest distance is therefore the distance of a candidate vector of the candidate vectors V000-Vn03 that has the least degree of similarity with the first query vector 106a among the vectors of the candidate vectors V000-Vn03 identified by the heap memory 114c. The longest distance will be used to execute a parallel pruning to cease analysis of candidate vectors of the candidate vectors V000-Vn03 at an early stage.

For example, for a period of time and until the heap memory 114c is full, the first-N similarity PEs 110a-110n may execute a full distance calculation between candidate vectors of the candidate vectors V000-Vn03 and the first query vector 106a and provide the total distances and vector IDs to the hardware heap engine 114. When the heap memory 114c is full, the first-N similarity PEs 110a-110n execute a partial pruning process to determine whether to prune computations of candidate vectors of the candidate vectors V000-Vn03 before a full distance calculation is completed.

For example, suppose that the longest distance retriever 114d identifies that the longest distance stored in the heap memory 114c is “3.” Suppose further that the first similarity PE 110a compares the first query vector 106a to candidate vector V002. For example, the first query vector 106a may have 512 features with each feature being approximately 1 byte. Similarly, the candidate vector V002 may have 512 features with each feature being approximately 1 byte. The first similarity PE 110a may compare the features at the same index (e.g., byte) position to determine how similar the features are to each other, and generate a distance based on the similarity. The first similarity PE 110a accumulates the distances (e.g., a summation of distances calculated thus far, a running average of distances calculated thus far, a weighted sum of distances calculated thus far, etc.) of the vector features that have been compared thus far together to form a partial distance. The partial distance may be distance accumulated on an ongoing distance compute. For example, if features of byte positions 0-3 of the candidate vector V002 and first query vector 106a are compared to each other and have associated distances, the partial distance would be the summation of the associated distances (e.g., partial distance=distance of features at byte value 0+distance of features at byte value 1+distance of features at byte value 2+distance of features at byte value 3). It is worthwhile to note that there may be 512 byte positions, and the partial distance only reflects a first portion (first four bytes) of those 512 byte positions. Thus, the partial distance is a running total of all the distances thus far computed between features of the candidate vector V0002 and the first query vector 106a.

If the partial distance exceeds the longest distance received from the longest distance retriever 114d, the first similarity PE 110a may stop determining the similarity between the candidate vector V002 and the first query vector 106a. For example, suppose that the partial distance of the candidate vector V002 and the first query vector 106a has a value of 4 (as accumulated over the first four bytes), while the longest distance has a value of 3. It may already be concluded that the candidate vector V002 is more dissimilar from the first query vector 106a than the candidate vectors of the candidate vectors V000-Vn03 that have already been analyzed to have associated distances stored in the heap memory 114c. That is, the longest distance represents the highest degree of dissimilarity in the heap memory 114c from the first query vector 106a, and any analysis of other candidate vectors of the candidate vectors V000-Vn03 may be bypassed and ignored (pruned) when the partial distance of the other candidate vector exceeds the longest distance, regardless of how much of the other candidate vectors are analyzed.

Doing so may save processing power and reduce latency. In this example, the candidate vector V002 has been analyzed for 4 byte positions and has already accumulated a partial distance that exceeds the longest distance. It is therefore reasonable to conclude that the candidate vector V002 will not be a final similarity match for the first query vector 106a. Thus, the remaining bytes of the candidate vector V002 do not need to be analyzed for similarity to the first query vector 106a, and the first similarity PE 110a discards further analysis of the candidate vector V002 in favor of analyzing other candidate vectors of the candidate vectors V000-Vn03.

Furthermore, the first-N similarity PEs 110a-110n operate in a cyclical fashion to avoid stalls and waiting; when pruning occurs while computing distance over index n features (e.g., byte positions) for a previous candidate vector, the distance calculation for next candidate vector begins from index n+1. This leverages the commutative and associative properties of distance compute which ensures that the distance calculated remains same irrespective of the partial compute starting from any feature index. For example, the candidate vector V002 is pruned based on comparing features of the candidate vector V002 and the first query vector 106a at byte positions 0-3. Thus, the first similarity PE 110a may have an index set to byte position 3. When the first similarity PE 110a begins compare the first query vector 106a to the candidate vector V003, the first similarity PE 110a may not reset the index to zero. Rather, the first similarity PE 110a compares features of the candidate vector V003 and the first query vector 106a at byte position 4 (index+1) which is the next byte position after the candidate vector V002 is discarded. If the last byte position is reached, the first similarity PE 110a may return to byte position 0 to determine distances at byte positions 0-3 of the candidate vector V003.

The first similarity PE 110a may iterate through all byte positions (including byte positions 0-4) of the candidate vector V003 and the first query vector 106a as long the partial distance does not exceed the long distance. Suppose that the partial distance does not exceed the longest distance and so all 512 bytes of the candidate vector V003 are analyzed. The final distance may be a summation of all the distances between the features of the first query vector 106a to the candidate vector V003. That is, the features at all 512 byte positions of the first query vector 106a and the candidate vector V003 are compared to generate distances that are summed together to form a total distance. If the total distance is less than the longest distance, the candidate vector V003 is determined to be in the top K nearest neighbor list at that point for the first query vector 106a and provided to the hardware heap engine 114. While byte positions are described above, some embodiments may operate on different feature vector sizes (INT8, INT16, INT32, FP32, BF16) with different index positions.

The first similarity PE 110a may transmit a vector ID of the candidate vector V003 and the total distance to the hardware heap engine 114 for storage. The heap controller 114b may store the vector ID of the candidate vector V003 and the total distance in the heap memory 114c and remove a vector ID associated with the longest distance, and the longest distance. The longest distance retriever 114d may select a new longest distance from the heap memory 114c and propagate the new longest distance to the first-N similarity PEs 110a-110n. Notably, since the candidate vector V002 computation was pruned, the first similarity PE 110a does not transmit the partial distance and vector ID of the candidate vector V002.

Thus, each of the first-N similarity PEs 110a-110n may execute a partial distance analysis by comparing a partial distance of the candidate vectors V000-Vn03 to a longest distance, and ceasing analysis once the partial distance is greater than the longest distance. After all of the candidate vectors V000-Vn03 have been analyzed for similarity to the first query vector 106a, the architecture 100 may output the results to a user or store the results. For example, a shortest distance and corresponding node ID may be identified in the heap memory 114c. A final vector of the candidate vectors V000-Vn03 may be identified based on the corresponding node ID, and output as the closest match to the first query vector 106a. In some examples, an application may request for all K nearest neighbors/closest candidate matches to a query vector, with the max value of K being the size of the heap memory 114c (e.g., a number of the nodes 0-n). The hardware heap engine 114 may then return the K distances and corresponding node IDs to the application.

The heap controller 114b may then remove all nodes from the heap memory 114c. The scheduler 104 may propagate a second query vector 106b to the first-N similarity PEs 110a-110n. The first-N similarity PEs 110a-110n may analyze the second query vector 106b for similarity to the candidate vectors V000-Vn03 similar to the above. After the similarity analysis of the second query vector 106b completes (comparisons to all candidate vectors V000-Vn03 completed), another query vector is streamed and analyzed in sequential order until the last N query vector 106n completes processing. Notably, throughout the streaming of the query vectors 106, the candidate vectors V000-Vn03 remain in memory areas 108 to avoid high latency memory accesses.

The memory areas 108 may be embedded static random-access memory (SRAM) that is embedded within the similarity search processor 116 (e.g., on chip). It is worthwhile to note also that variations in the heap memory 114c are possible (e.g., min-heap binary tree storage or max-heap binary tree storage).

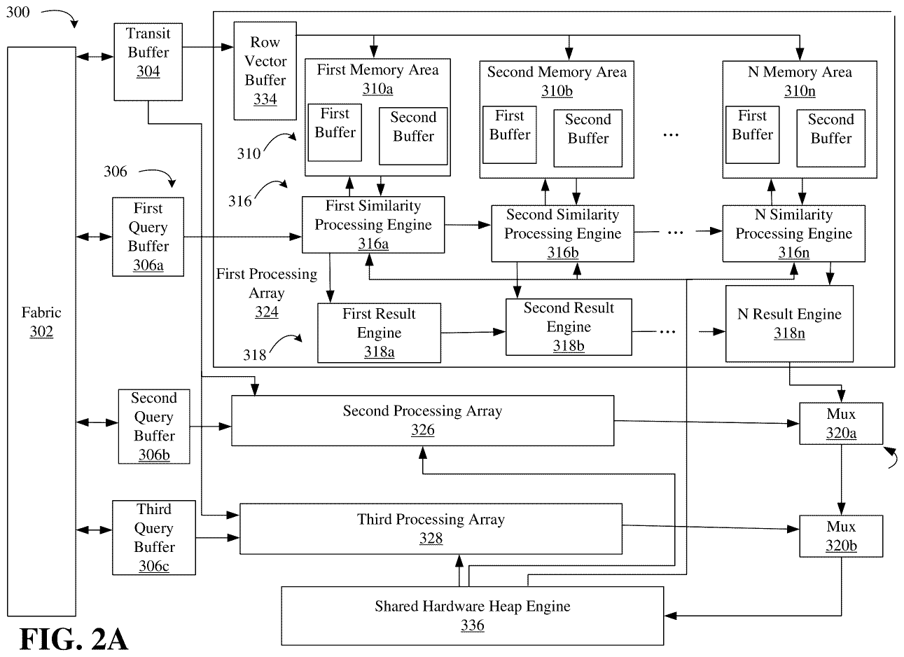

Turning now to FIGS. 2A-2B, an architecture 300 for far-memory similarity search matching is disclosed. The architecture 300 operates similarly to the architecture 100 described above, and similar features will not be described in detail for brevity. It will be understood however that aspects of architecture 100 are readily incorporated into architecture 300.

As illustrated, a first processing array 324, a second processing array 326 and a third processing array 328 are provided. The first processing array 324, the second processing array 326 and the third processing array 328 may be located on a same SoC and/or form part of a same processor. The first processing array 324 is illustrated in detail, but it will be understood that the second and third processing arrays 326, 328 are composed of similar features and elements that are not illustrated for brevity. The first processing array 324, the second processing array 326 and the third processing array 328 may process different queries in parallel to one another.

In this example, the candidate vectors cannot fit entirely within first-N memory areas 310-314, and thus are retrieved and removed as desired. In this example, transit buffer 304 and query buffers 306 receive both query and vector data from a fabric 302 which may be a network on chip fabric. A transit buffer 304 is of a suitable size to buffer candidate vectors from a candidate vector database (which may be stored in an off-chip storage).

Each of the similarity PEs 316 is connected to a dedicated memory area of the memory areas 310. Each of the memory areas 310 may operate as a “circular ping pong vector buffer” (CPPVB) which stores two database vectors in a first and second buffer. To operate as a CPPVB, the first and second buffers of the memory areas 310 store multiple vectors at a time. For example, suppose that the first similarity PE 316a completes processing a candidate vector in one buffer of the first and second buffers of the first memory area 310a. The one buffer is refilled from the row vector buffer 334 while the first similarity PE 316a processes a candidate vector in the other of the first and second buffers.

The similarity PEs 316 are connected a 1-D systolic array fashion. The results from the similarity PEs 316 are daisy chained through the results engines 318 to form a single stream of results that are transmitted to multiplexer (MUX) 320a. The MUX 320a may provide the results to MUX 320b, which provides the results to a shared hardware heap engine (SHHE) 336. The SHHE 336 will be discussed in further detail with respect to FIG. 2B, which illustrates the SHHE 336 in detail.

The similarity PEs 316 may compute similarity searches for a same query (e.g., a same query vector). The query streaming mechanism with the first query buffer 306a is the same as that of query buffer 102 (FIG. 1) and will not be repeated in detail. As stated above, each of the similarity PEs 316 is connected to one memory area of the first-N memory areas 310a-310n, where the one memory area includes a CPPVB. For example, the first memory area 310a includes a CPPVB comprising a first and second buffer. The first and second buffer store two vectors from database for comparison to a query. Each feature in the vectors stored in the first and second buffers is iteratively streamed to the first similarity PE 316a.

For example, initially, all similarity PEs 316 begin computations on the first feature in the associated first buffers. Each clock cycle, the similarity PEs 316 receive buffers streams from the first buffers and determine the similarity between “i-th” feature of the candidate vectors and the query vector to determine partial distances. When a candidate vector computation is pruned, the query stream index is not interrupted. For example, the SHHE 336 may provide a longest distance. Suppose that the first similarity PE 316a determines that at feature index “i,” (e.g., a byte position) a first candidate vector in the first buffer of the first memory area 310a is to be discarded (e.g., based on a partial distance being greater than a longest distance). The first similarity PE 316a accesses the second buffer of the first memory area 310a to retrieve a second candidate vector from the second buffer without interrupting the flow of query bytes being streamed. The first similarity PE 316a analyzes the similarity between the second candidate vector and the query vector beginning at feature index “i+1” and continues in a circular fashion until either all features are processed, or the second vector computation is pruned.

While the first similarity PE 316a executes the similarity analysis based on the second candidate vector, the row vector buffer 334 may store a third candidate vector into the first buffer of the first memory area 310a. After the processing of the second vector is completed or the second vector computation is pruned, the first similarity PE 316a switches to the first buffer and begins a similarity analysis on the third candidate vector. The row vector buffer 334 may begin storing a fourth candidate vector in the second buffer for the first similarity PE 316a for analysis. Thus, the first similarity PE 316a ping-pongs between the first and second buffers. The second-N similarity PEs 316b-316n may similarly access candidate vectors from the first and second buffers of the first-N memory areas 310b-310n in a ping-pong fashion.

The transit buffer 304 fetches the vector database (e.g. 1 billion candidate vectors) from system memory (not illustrated). Candidate vectors in the transit buffer 304 are broadcast to all row vector buffers of the first, second and third processing array 324, 326, 328 including the row vector buffer 334. The first buffers and the second buffers fetch the candidate vectors from the row vector buffer 334. As the first-N similarity PEs 316a-316n compute similarity measurements for the same query, the candidate vectors stored in the first and second buffers are different and mutually exclusive. It is worthwhile to note that each of the first, second and third processing arrays 324, 326, 328 may store the same candidate vectors.

For example, each of the first, second and third processing arrays 324, 326, 328 may receive a first candidate vector and conduct a similarity analysis on the first candidate vector. When all of the first, second and third processing arrays 324, 326, 328 have received the first candidate vector, the transit buffer 304 remove the first candidate vector from memory of the transit buffer 304 and replaces the first candidate vector with a new vector (e.g., second candidate vector) from fabric 302. Row vector buffers, including the row vector buffer 334, may then provide the new vector to the first, second and third processing arrays. The fetching of vectors by the transit buffer 304 and pulls by row vector buffers, such as row vector buffer 334, occurs continuously until the entire database gets is analyzed for similarity.

As described above, the second and third processing arrays 326, 328 are composed of similar components as the first processing array 324. A second query buffer 306b may provide queries to the second processing array 326. A third query buffer 306c may provide queries to the third processing array 328.

In the architecture 300, the first, second and third processing arrays 324, 326, 328 conduct similarity searches over multiple different queries in parallel. The SHHE 336 operates similarly to the hardware heap engine 114 (FIG. 1) with the added capability of handling data related to several distinct query searches and executing pruning based on partial distances as described above. The results from each first-N similarity PE 316a-316n are daisy chained through the first-N results engine 318a-318n. Each of the first-N result engine 318a-318n may include two buffers to store results in the event of backpressure or slowing of transmission of the results through the first-N results engine 318a-318n.

The outputs from the first, second and third processing arrays 324, 326, 328 are provided to MUXs 320a, 320b to generate a single stream of results from the first, second and third processing arrays 324, 326, 328. FIG. 2B illustrates a more detailed view of the SHHE 336 with relevant components from FIG. 2A being illustrated as well. Turning now to FIG. 2B, to avoid collision and backpressure for writes into SHHE 336, the results stream may be stored in a large sized buffer 332 (e.g., 64 deep elastic buffer). The heap controller 330 reads a candidate vector ID, corresponding query ID, and corresponding distance stored in the buffer 332 and controls an insertion flow into the corresponding partition for the query ID.

For example, the first, second and third processing arrays 324, 326, 328 may provide outputs that include a candidate vector ID corresponding to a candidate vector that is compared against a query vector, total distance associated with the candidate vector and a query vector, and a query ID that corresponds to the query vector. The query ID may be referenced to determine whether to store the candidate vector and the corresponding total distance in a first heap memory 322a, second heap memory 322b or a third heap memory 322c of a heap memory 322. The first heap memory 322a may store results from the first processing array 324 associated with the first query in nodes 0-n. The second heap memory 322b may store results from the second processing array 326 associated with a second query in nodes 0-n. The third heap memory 322c may store results from the third processing array 328 associated with a third query in nodes 0-n.

For example, suppose that the second processing array 326 analyzes a first candidate vector for similarity against a second query vector. The second processing array 326 may determine that the total distance of the first candidate vector is below a longest distance associated with the second query vector. Thus, the second processing array 326 may provide an output to the MUX 320a including a first candidate vector ID, a second query ID (that is associated with the second query vector) and the total distance. The MUXs 320a, 320b may provide the output to the SHHE 336. The SHHE 336 may receive and store the output in buffer 332 until the heap controller 330 is ready to store the output. The heap controller 330 may receive the output and extract the second query ID. The second query ID may correspond to the second heap memory 322b. That is, each result associated with the second query vector may be stored in the second heap memory 322b. The heap controller 330 may therefore store the first candidate vector ID and distance in association with each other within the second heap memory 322b. Thus, the heap controller 330 may identify query IDs to determine where to store candidate vector IDs and distances.

A longest distance retriever 338 further determines the long distance from the first heap memory 322a. The long distance of the first heap memory 322a may be the longest distance of the first query that is stored in the first heap memory 322a. The longest distance retriever 338 further provides the long distance of the first query to the first processing array 324. The longest distance retriever 338 further determines the long distance from the second heap memory 322b. The long distance of the second heap memory 322b may be the longest distance of the second query that is stored in the second heap memory 322b. The longest distance retriever 338 further provides the long distance of the second query to the second processing array 326. The longest distance retriever 338 further determines the long distance from the third heap memory 322c. The long distance of the third heap memory 322c may be the longest distance of the third query that is stored in the third heap memory 322c. The longest distance retriever 338 further provides the long distance of the third query to the third processing array 328. The first processing array 324 may execute a pruning process based on the long distance of the first query. Similarly, the second and third processing arrays 326, 328 may execute pruning processes based on the long distances of the second and third queries, respectively.

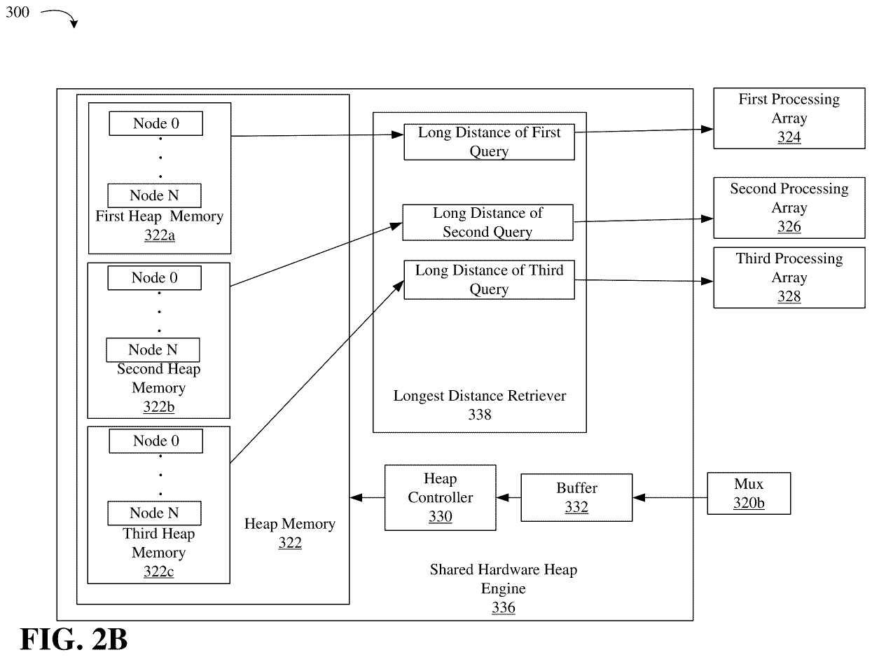

FIG. 3 shows a method 800 of a similarity search process with pruning. The method 800 may generally be implemented with the embodiments described herein, for example, the architecture 100 (FIG. 1) and/or the architecture 300 (FIGS. 2A-2B), already discussed. In an embodiment, the method 800 is implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 800 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 802 determines, with a first processing engine of a plurality of processing engines, a first partial similarity measurement based on a first portion of a query vector and a first portion of a first candidate vector. Illustrated processing block 804 determines, with a second processing engine of the plurality of processing engines, a total similarity measurement based on the query vector and a second candidate vector. Illustrated processing block 806 determines, with the first processing engine, whether to compare a second portion of the query vector to a second portion of the first candidate vector based on the first partial similarity measurement and the total similarity measurement.

In some embodiments, the method 800 further includes comparing, with the first processing engine, the second portion of the query vector to the second portion of the first candidate vector in response to the first partial similarity measurement being less than the total similarity measurement, where the first partial similarity measurement is a partial distance and the total similarity measurement is a total distance. In some examples, the method 800 further includes retrieving, with the plurality of processing engines, different candidate vectors, determining, with the plurality of processing engines, a plurality of partial similarity measurements between first portions of the query vector and first portions of the different candidate vectors and determining, with the plurality of processing engines, whether to bypass partial similarity computations between second portions of the query vector and second portions of the different candidate vectors based on the plurality of partial similarity measurements and the total similarity measurement.

In some examples, the method 800 further includes accessing a plurality of memory storage areas that are each dedicated to one of the plurality of processing engines. The plurality of memory storage areas to store the different candidate vectors. The different candidate vectors are to represent a vector candidate database. In some examples, the method 800 further includes determining, with the first processing engine, to bypass a similarity computation of the first candidate vector based on the first partial similarity measurement and the total similarity measurement. An index to the query vector is at a value when the first partial similarity measurement is determined. In response to the similarity computation of the first candidate vector being bypassed, the method 800 increments, with the first processing engine, the value of the index and determines, with the first processing engine, whether to bypass a similarity computation of a third candidate vector based on a partial similarity measurement that is determined based on a feature value of the third candidate vector and a feature value of the query vector, wherein the feature value of the third candidate vector and the feature value of the query vector are both associated with the incremented value of the index.

In some examples, the method 800 further includes storing the total similarity measurement and a plurality of similarity measurements in a max-heap binary tree or a min-heap binary tree. The plurality of similarity measurements is determined based on different candidate vectors and the query vector. The total similarity measurement is larger than each of the plurality of similarity measurements. In some examples, the method 800 further includes storing a plurality of candidate vectors in a plurality of ping-pong buffers, determining, with the plurality of processing engines, a plurality of partial similarity measurements based on first portions of a plurality of query vectors and first portions of the plurality of candidate vectors and determining, with the plurality of processing engines, that similarity computations associated with a first subset of the plurality of candidate vectors will be bypassed based on a first subset of the plurality of partial similarity measurements and first total similarity measurements.

In some examples, the method 800 further includes determining, with a group of the plurality of processing engines, that a second subset of the plurality of candidate vectors will be processed based on a second subset of the plurality of partial similarity measurements and the first total similarity measurements. The method 800 further includes determining, with the group of the plurality of processing engines, second total similarity measurements based on the second subset of the plurality of candidate vectors and the plurality of query vectors, and storing each respective total similarity measurement of the second total similarity measurements into different heap memories based on an identification of a query vector of the plurality of query vectors associated with the respective total similarity measurement. Each of the different heap memories is dedicated to one of the plurality of query vectors.

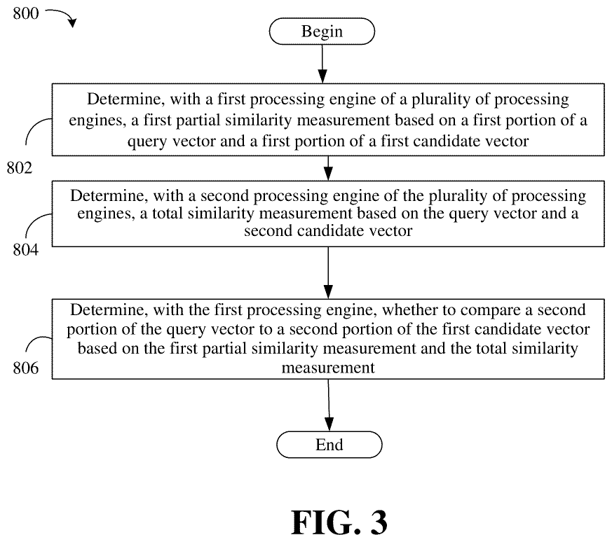

FIG. 4 illustrates a timing diagram 400 of PE0 402 and PE0n 404. The PE0 402 and PE0n 404 may be readily substituted for any of the similarity PEs 110 (FIG. 1) and similarity PEs 316 (FIGS. 2A-2B). The PE0 402 and PE0n 404 operate on a query with 512 features, each feature having size of 1 byte. The 512 bytes in the query are represented as Q0, Q1 . . . Q511 in the timing diagram 400. The diagram presents two cases, one of compute pruning on PE0 402 and compute acceptance on PE0n 404.

At the beginning of the timing diagram 400 and with reference to signals 406, the PE0 402 compares query vector Q with candidate vector V00 (as shown in the buffer/vector number row) from a memory bank 0. At the 226th clock cycle (which occurs at Q226) the accumulated partial distance 226 (on hatched background) for v00 is greater than the largest distance (which may be received from a hardware heap engine or SHHE) and the similarity compute of V00 is pruned (e.g., ended) at an index of 226. In the next clock cycle, candidate vector v01 is loaded into PE0 402 and Q227 from the query vector is used to compute a similarity distance from the 227th feature (V227, which is at the index +1 position) from candidate vector v01. Thus, PE0 402 begins the distance calculation against the next database candidate vector v01. PE0 402 continues the similarity computation cyclically to indices 511, and then to indices 0, 1 . . . 226 unless pruning occurs and the compute is dropped.

The query stream is shared among the PE0 and PE0n 402, 404. Thus, both the PE0 and PE0n 402, 404 operate on the same query vector. In the bottom signals 408 of the timing diagram 400, PE0n 404 compares the query byte Q0 with candidate vector vn0 at an offset of n clock cycles with respect to PE0 402 over a time difference between time B and time A. This is in part due to the daisy chain transmission of the query vector throughout PEs including the PE0 402 and PE0n 404. Thus, the PE0n 404 receives the query vector after PE0 402. PE0n 404 calculates partial distances on the query features and corresponding vector features of candidate vector vn0 for 512 clock cycles and does not exceed the longest distance. After 512th clock cycle (511st clock cycle when 0-indexed) the partial distance is still less than the long distance. Hence the candidate vector vn0 qualifies as a candidate for K nearest neighbors for the query vector and is pushed as a result to a hardware heap engine or SHHE for storage. In the next clock cycle, PE0n 404 selects feature Q0 from the query vector. PE0n 404 selects feature 0 (V0) from a new candidate vector vn1 to start computing partial distances.

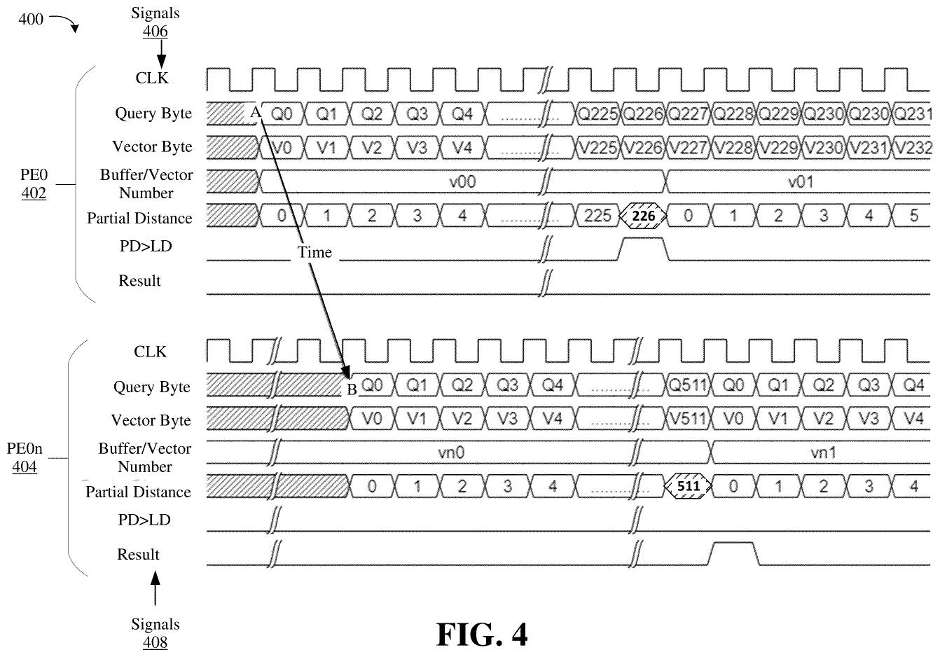

FIG. 5 shows a query streaming method 500. The method 500 may generally be implemented with the embodiments described herein, for example, the architecture 100 (FIG. 1), architecture 300 (FIGS. 2A-2B), and/or timing diagram 400 (FIG. 4) already discussed. For example, the method 500 may be executed by scheduler 104 of query buffer 102 (FIG. 1) and/or query buffers 306 (FIGS. 2A-2B) The method 500 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 502 streams a selected query vector to a plurality of similarity PEs. Illustrated processing block 504 determines if the selected query vector is compared against all candidate vectors. If not, processing block 502 executes. Otherwise, illustrated processing block 506 determines if all query vectors are completed. If not, illustrated processing block 508 selects a new query vector as the selected query vector, and processing block 502 executes to process the selected query vector and compute similarity measurements of the selected query vector against candidate vectors.

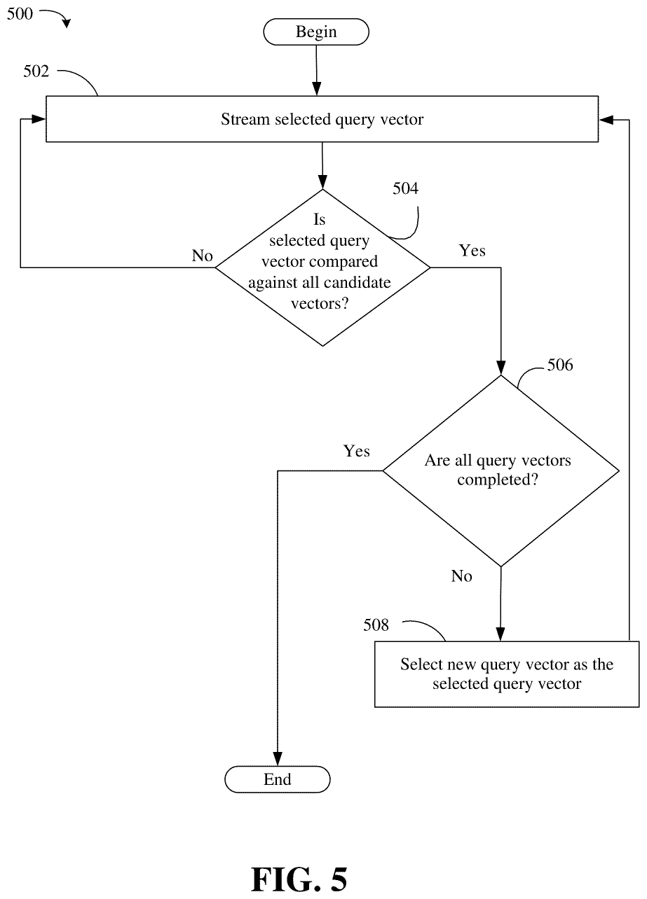

FIG. 6 shows a similarity computation method 530 that is implemented by a similarity PE. The method 530 may generally be implemented with the embodiments described herein, for example, the architecture 100 (FIG. 1), architecture 300 (FIGS. 2A-2B), timing diagram 400 (FIG. 4) and/or method 500 (FIG. 5) already discussed. For example, the method 530 may be executed by similarity PEs 110 (FIG. 1) and/or similarity PEs 316 (FIG. 2A). The method 530 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 542 sets an index value to zero. The index value may be a byte position (or correspond to a feature vector size of query and candidate vectors) that the similarity PE will reference to compare feature values of a candidate vector and query vector at the byte position, and determine a similarity measurement. That is, the similarity PE initially starts fetching address 0 for candidate and query vectors. So initially both query vector and candidate vector start with index 0.

Illustrated processing block 532 computes a feature distance for features of the query vector at the index value and the candidate vector at the index value. Illustrated processing block 534 adds the feature distance to a partial distance to generate a sum, and sets the sum as the new partial distance. In some examples, processing block 534 calculates an average of distances calculated thus far or a weighted sum of distances calculated thus far and sets the value as the partial distance. Illustrated processing block 536 determines if the partial distance is greater than a longest distance.

If the partial distance is greater than the longest distance, the rest of the compute is pruned away for the candidate vector. For example, illustrated processing block 544 determines if any more candidate vectors exist. If so, illustrated processing block 546 selects a new candidate vector from the remaining candidate vectors and sets the partial distance to zero. Processing block 548 increments the index value. Processing block 532 then executes.

If processing block 536 determines that the longest distance is greater than the partial distance, illustrated processing block 538 determines if the last feature in the candidate vector is reached. If not, illustrated processing block 540 increments the index value so that processing block 532 computes a vector distance of features at the incremented index value and so forth. If processing block 538 determines that the last feature in the candidate vector is reached, illustrated processing block 542 pushes the results to a sort engine (e.g., a hardware heap engine or SHHE). That is, once the partial distance for all features are accumulated and the final and total distance (which is the accumulation of all partial distances) is still less than the longest distance, the results are sent to the sorting engine.

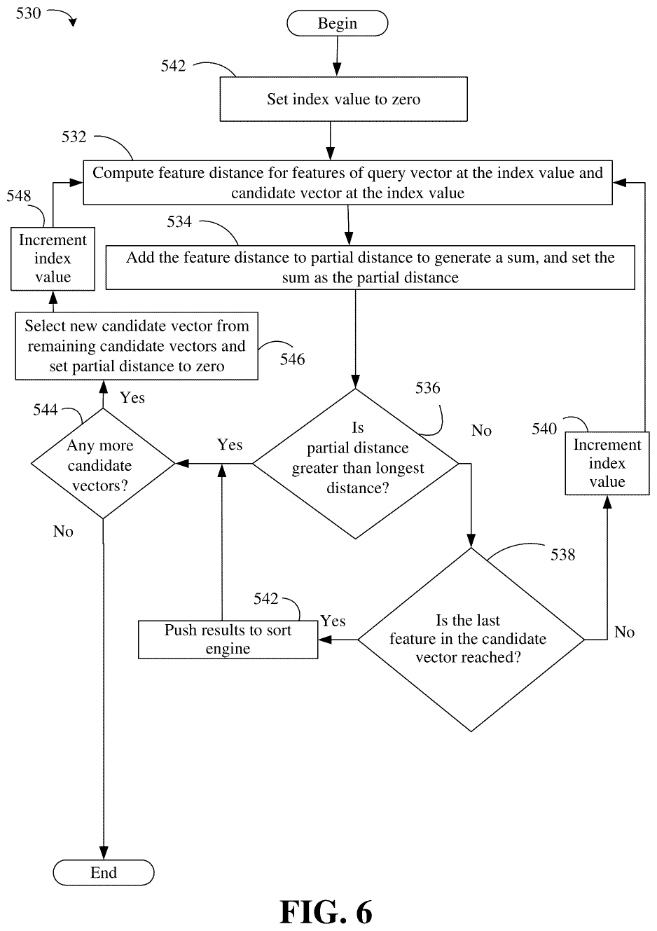

FIG. 7 illustrates a heap memory structure 550 that is a binary tree. The heap memory structure 550 may generally be implemented with the embodiments described herein, for example, the architecture 100 (FIG. 1), architecture 300 (FIGS. 2A-2B), timing diagram 400 (FIG. 4), method 500 (FIG. 5) and/or method 600 (FIG. 6) already discussed. For example, the nodes 0-n of the heap memory 114c (FIG. 1), nodes 0-n of the first heap memory 322a (FIG. 2B), nodes 0-n of the second heap memory 322b (FIG. 2B) and/or nodes 0-n of the third heap memory 322c (FIG. 2B) may be organized into the heap memory structure 550.

The heap memory structure 550 may include nodes 1-15 organized in the heap structure and are numbered from root (node 1) to leaf (nodes 8-15) (e.g., pre-order sequencing). The node numbering corresponds to the store location (node index) in the hardware heap engine. The hardware heap engine partitions a common memory to store K Nearest Neighbors (KNN) for a batch of queries, where K as well as batch size is configurable. The number of nodes (fifteen) is exemplary, and embodiments as described herein may include any number of nodes and may be determined on a number of KNN values that are to be stored (e.g., twenty KNN values would result in twenty nodes).

In the structure 550, the heap memory structure 550 is configured to store the fifteen closest vectors in each partition, for a query. The heap binary structure may be a max-heap binary tree in which the root node 1 has the greatest distance value, the first level (i.e., nodes 2 and 3) have the next greatest distance values, the second level (i.e., nodes 4-7) have the next greatest distance values and the bottom level (i.e., nodes 8-15) have the lowest distance values. As will be explained in further detail, a max-heap binary tree may be an efficient storage structure since the longest distance is always maintained and the root of the tree and may be easily identified.

Moreover, insertion of a new value into the tree may be executed efficiently. For example, if a new distance value is to be inserted into the structure 550, the distance value in node 1 (the longest distance) is automatically removed. The new distance value may be compared to a distance value of node 2. If the distance heap value of node 2 is greater than the new distance value, then the distance value (and corresponding candidate vector ID) in node 2 may be moved to node 1, and the new distance value may occupy node 2. The new distance value is then compared to the distance of one child node (nodes 4 and 5) of node 2, and swapped with the one child node if the new distance is less than that of the one child node. This process may repeat until the new distance is no longer smaller than children nodes of a currently occupied node of the new distance, or the position of the new distance is in the bottom of the max-bin heap tree. Notably, the new distance does not have to be compared to all the distances of nodes 2-15, but only needs to execute three comparisons (at most) to find a final position. That is, an exact ordering of distances from greatest to smallest is not needed, only the greatest distance must be identified and is contained at node 1. Furthermore, each of the nodes 1-15 may include a candidate vector ID that corresponds to the distance value stored in the respective node (e.g., the candidate vector ID of a candidate vector that underwent a similarity computation process to generate the distance value stored in the node).

The structure 550 may be replicated for each partition, query memory or query. A copy of the root of Node 1 is stored in a register in hardware and broadcast as the longest distance to the appropriate similarity PEs operating on the respective query for comparing and eliminating redundant results.

In some examples, when a distance computation is not pruned/dropped, the distance result is daisy chained to the Hardware Heap Engine (HHE) which creates structure 550. The HHE is an apparatus for a hardware friendly implementation of the traditional heap. A heap, specifically a max heap or max-heap binary tree, may efficiently store distances for k “nodes” and easily access the largest distance from the root node 1. The property of a Max Heap is that the value in a node must be greater than its child nodes, conversely for Min Heap the value of a node must be smaller than the child nodes. Thus, the root node 1 of structure 550 contains the largest element in the data structure 550. HHE may be configured to perform as Max Heap or Min Heap in some embodiments.

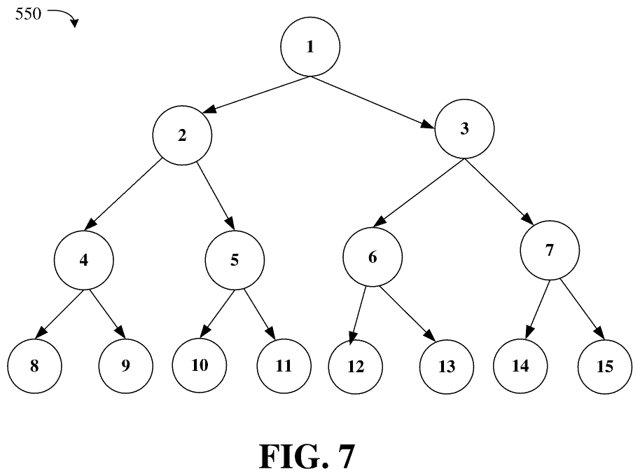

FIG. 8 shows a method 420 that is implemented by a HHE and/or SHHE to fill an uncompleted (not yet completely filled) structure (e.g., binary tree). The method 420 may generally be implemented with the embodiments described herein, for example, the architecture 100 (FIG. 1), architecture 300 (FIGS. 2A-2B), timing diagram 400 (FIG. 4), method 500 (FIG. 5), method 530 (FIG. 6) and/or structure 550 (FIG. 7) already discussed. For example, the method 420 may generate the structure 550 (FIG. 7). The method 420 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 422 identifies a new node entry. Illustrated processing block 424 stores the new node entry in the first available location starting from index 1 (e.g., from the root node downward to lower levels). Illustrated processing block 426 determines if the new node location is at a root node. If so, no further action is needed. If the current location is a non-root node, the current location is a child node. Thus, illustrated processing block 428 determines if the distance value of the new node entry (that is stored in the child node) is greater than the distance of a parent node of the new node location (the child node). If not, no action is needed. Otherwise, if the current node distance is greater than the distance of the parent node, illustrated processing block 430 moves the new node entry to the parent node and moves the parent node entry to the child node. That is, illustrated processing block 430 swaps the node entry of the parent with the new node entry in the child node. Illustrated processing block 426 then executes again with the new node location being set to the parent node location.

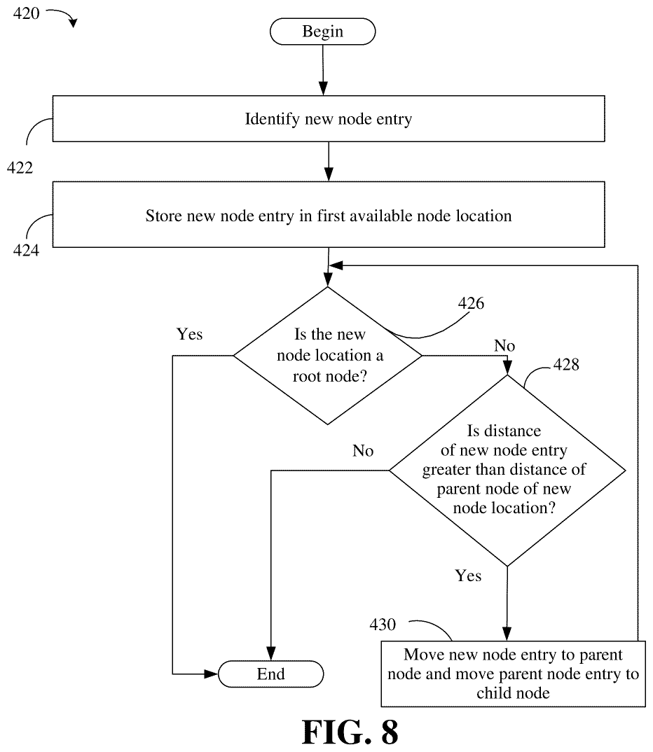

FIG. 9 shows a method 440 that is implemented by a HHE and/or SHHE to insert a new node entry into a filled structure (e.g., binary tree with all nodes occupied). The method 440 may generally be implemented with the embodiments described herein, for example, the architecture 100 (FIG. 1), architecture 300 (FIGS. 2A-2B), timing diagram 400 (FIG. 4), method 500 (FIG. 5), method 530 (FIG. 6), structure 550 (FIG. 7) and/or method 420 (FIG. 8) already discussed. For example, the method 440 may update the structure 550 (FIG. 7). The method 440 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 442 inserts a new node entry (which has a total distance that is less than a longest distance of the head or root node) into a head node of a max-heap binary tree. The entry that was previously in the head of the max-heap binary tree is deleted and removed from the max-heap binary tree. Illustrated processing block 444 reads distances of a left child node and a right child node of the parent node. Illustrated processing block 446 determines if the distance of the right child node is greater than the distance of the left child node. If so, illustrated processing block 454 determines if the distance of the right child node is greater than the distance of the parent node. If not method 440 ends. If processing block 454 determines that the distance of the right child node is greater than the distance of the parent node, illustrated processing block 450 swaps the node entry of the parent node with the entry in the right child node. Illustrated processing block 452 determines if the right child node is a leaf node (bottom layer of the binary tree). If so, the method 440 may end. Otherwise illustrated processing block 460 sets the right child node to the parent node and processing block 444 executes.

If processing block 446 determines that the distance of the right child node is not greater than the distance of the left child node, illustrated processing block 448 executes. Processing block 448 determines if the distance of the left child node is greater than the distance of the parent node. If not, method 440 ends. If processing block 448 determines that the distance of the left child node is greater than the distance of the parent node, illustrated processing block 456 swaps the node entry of the parent node with the entry in the left child node. Illustrated processing block 458 determines if the left child node is a leaf node. If not, illustrated processing block 462 sets the left child node to the parent node. Otherwise, the method 440 ends.

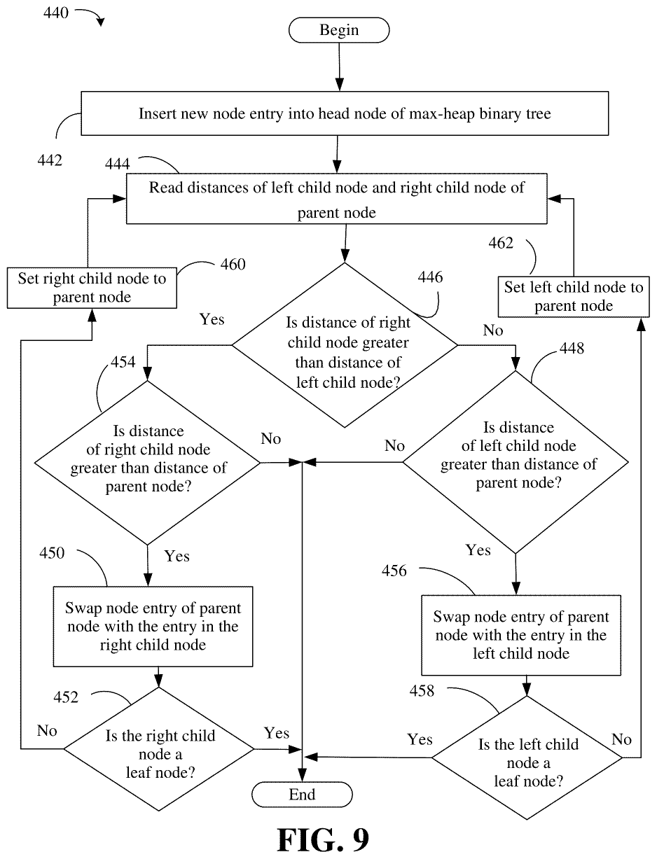

Turning now to FIG. 10, a similarity search and pruning query processing computing system 158 is shown. The system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the system 158 includes a host processor 160 (e.g., CPU) having an integrated memory controller (IMC) 154 that is coupled to a system memory 164.

The illustrated system 158 also includes an input output (IO) module 166 implemented together with the host processor 160, a graphics processor 162 (e.g., GPU), a similarity search processor 150, ROM 140, and AI accelerator 148 on a semiconductor die 170 as a system on chip (SoC). The illustrated IO module 166 communicates with, for example, a display 172 (e.g., touch screen, liquid crystal display/LCD, light emitting diode/LED display), a network controller 174 (e.g., wired and/or wireless), FPGA 178 and mass storage 168 (e.g., hard disk drive/HDD, optical disk, solid state drive/SSD, flash memory). Furthermore, the SoC 170 may further include processors (not shown) and/or the AI accelerator 148 dedicated to artificial intelligence (AI) and/or neural network (NN) processing. For example, the system SoC 170 may include vision processing units (VPUs,) and/or other AI/NN-specific processors such as AI accelerator 148, etc. In some embodiments, any aspect of the embodiments described herein may be implemented in the processors and/or accelerators dedicated to AI and/or NN processing such as AI accelerator 148, the graphics processor 162, the host processor 160 and/or the similarity search processor 150.

The similarity search processor 150 may execute instructions 156 retrieved from the system memory 164 (e.g., a dynamic random-access memory) and/or the mass storage 168 to implement aspects as described herein. The similarity search processor 150 may include PE₁-PEₙ 152 that execute batch processing, similarity searching of candidate vectors to query vectors and early pruning of computations of candidate vectors. In order to do so, some examples may store the candidate vectors in the memory storage areas 144 with partitions being dedicated to one of the PE₁-PEₙ 152. If the candidate vectors are too large to fit in the memory storage areas 144, a subset of the candidate vectors may be stored in the ping-pong buffers 142 (e.g., static random-access memory) that the PE₁-PEₙ 152 access to compare query vectors to subset of the candidate vectors. The query and candidate vectors may be stored in mass storage 168 when not in use, and moved to the memory storage areas 144, ping-pong buffers 142 and/or system memory 164 when similarity searching is to execute. When the instructions 156 are executed, the computing system 158 may implement one or more aspects of the embodiments described herein. For example, the system 158 may implement one or more aspects of the architecture 100 (FIG. 1), architecture 300 (FIGS. 2A-2B), timing diagram 400 (FIG. 4), method 500 (FIG. 5), method 530 (FIG. 6), structure 550 (FIG. 7), method 420 (FIG. 8) and/or method 440 (FIG. 9) already discussed. The illustrated computing system 158 is therefore considered to be performance-enhanced at least to the extent that it enables the computing system 158 to take advantage of low latency similarity searching and pruning processes to reduce processing power, overhead and far memory accesses. In some examples, the memory storage areas 144 may operate and include the ping-pong buffers 142 when desired.

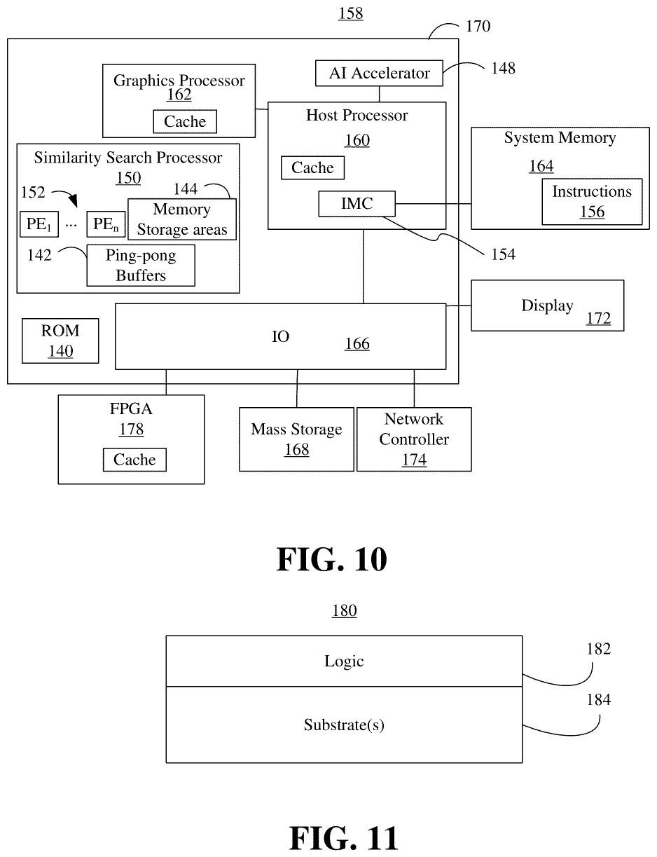

FIG. 11 shows a semiconductor apparatus 180 (e.g., chip, die, package). The illustrated apparatus 180 includes one or more substrates 184 (e.g., silicon, sapphire, gallium arsenide) and logic 182 (e.g., transistor array and other integrated circuit/IC components) coupled to the substrate(s) 184. In an embodiment, the apparatus 180 is operated in an application development stage and the logic 182 performs one or more aspects of the architecture 100 (FIG. 1), architecture 300 (FIGS. 2A-2B), timing diagram 400 (FIG. 4), method 500 (FIG. 5), method 530 (FIG. 6), structure 550 (FIG. 7), method 420 (FIG. 8) and/or method 440 (FIG. 9) already discussed. Thus, the logic 182 may determining, with a first processing element of a plurality of processing elements, a first partial similarity measurement based on a first portion of a query vector and a first portion of a first candidate vector, determine, with a second processing element of the plurality of processing elements, a total similarity measurement based on the query vector and a second candidate vector and determine, with the first processing element, whether to compare a second portion of the query vector to a second portion of the first candidate vector based on the first partial similarity measurement and the total similarity measurement. Furthermore, the logic 182 may further include processors (not shown) and/or AI accelerator dedicated to artificial intelligence AI and/or NN processing. For example, the system logic 182 may include VPUs, and/or other AI/NN-specific processors such as AI accelerators, similarity search PEs, etc. In some embodiments, any aspect of the embodiments described herein may be implemented in the processors and/or accelerators dedicated to AI and/or NN processing such as AI accelerators.

The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

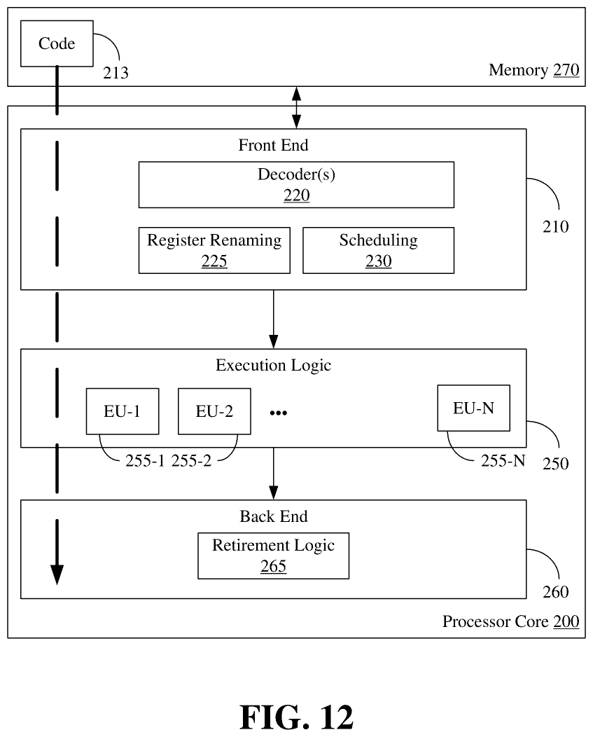

FIG. 12 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 12, a processing element may alternatively include more than one of the processor core 200 illustrated in FIG. 12. The processor core 200 may be a single-threaded core or, for at least one embodiment, the processor core 200 may be multithreaded in that it may include more than one hardware thread context (or “logical processor”) per core.

FIG. 12 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the architecture 100 (FIG. 1), architecture 300 (FIGS. 2A-2B), timing diagram 400 (FIG. 4), method 500 (FIG. 5), method 530 (FIG. 6), structure 550 (FIG. 7), method 420 (FIG. 8) and/or method 440 (FIG. 9) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 12, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

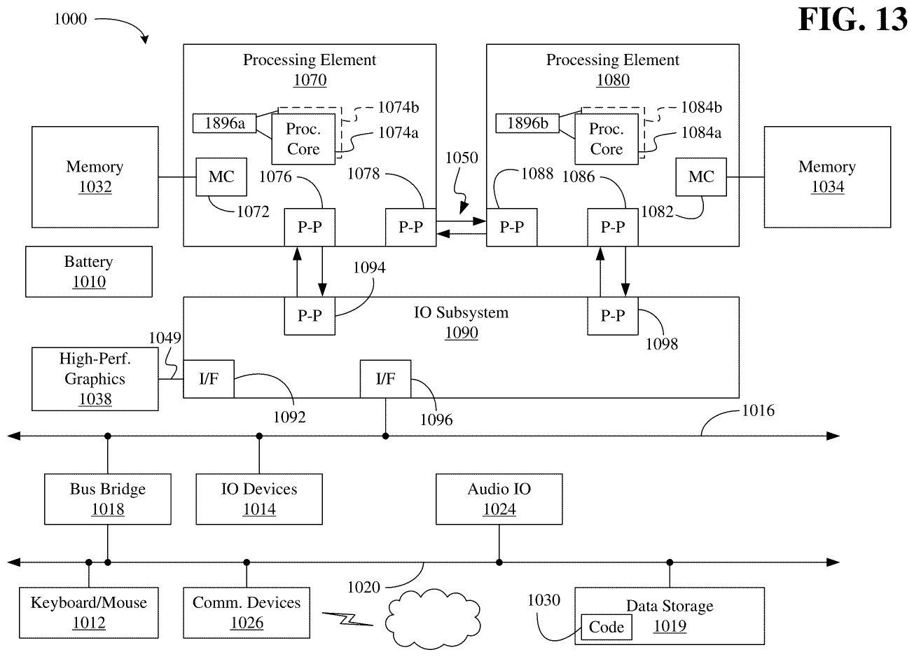

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the architecture 100 (FIG. 1), architecture 300 (FIGS. 2A-2B), timing diagram 400 (FIG. 4), method 500 (FIG. 5), method 530 (FIG. 6), structure 550 (FIG. 7), method 420 (FIG. 8) and/or method 440 (FIG. 9) already discussed. Further, an audio I/O 1024 may be coupled to second bus 1020 and a battery 1010 may supply power to the computing system 1000.

Note that other embodiments are contemplated. For example, instead of the point-to-point architecture of FIG. 12, a system may implement a multi-drop bus or another such communication topology. Also, the elements of FIG. 12 may alternatively be partitioned using more or fewer integrated chips than shown in FIG. 12.

### Additional Notes and Examples

Example 1 includes a computing system comprising a system-on-chip that is to include a plurality of processing engines, and a memory including a set of executable program instructions, which when executed by the system-on-chip, cause the computing system to determine, with a first processing engine of the plurality of processing engines, a first partial similarity measurement based on a first portion of a query vector and a first portion of a first candidate vector, determine, with a second processing engine of the plurality of processing engines, a total similarity measurement based on the query vector and a second candidate vector, and determine, with the first processing engine, whether to compare a second portion of the query vector to a second portion of the first candidate vector based on the first partial similarity measurement and the total similarity measurement.
Example 2 includes the computing system of Example 1, wherein the instructions, when executed, further cause the computing system to compare, with the first processing engine, the second portion of the query vector to the second portion of the first candidate vector in response to the first partial similarity measurement being less than the total similarity measurement, wherein the first partial similarity measurement is to be a partial distance and the total similarity measurement is to be a total distance.
Example 3 includes the computing system of Example 1, wherein the instructions, when executed, further cause the computing system to retrieve, with the plurality of processing engines, different candidate vectors, determine, with the plurality of processing engines, a plurality of partial similarity measurements between first portions of the query vector and first portions of the different candidate vectors, and determine, with the plurality of processing engines, whether to bypass partial similarity computations between second portions of the query vector and second portions of the different candidate vectors based on the plurality of partial similarity measurements and the total similarity measurement.
Example 4 includes the computing system of Example 3, wherein the system-on-chip is to include a plurality of memory storage areas that are each dedicated to one of the plurality of processing engines, wherein the plurality of memory storage areas is to store the different candidate vectors, wherein the different candidate vectors are to represent a vector candidate database.
Example 5 includes the computing system of Example 1, wherein the instructions, when executed, further cause the computing system to determine, with the first processing engine, to bypass a partial similarity computation of the first candidate vector based on the first partial similarity measurement and the total similarity measurement, wherein an index to the query vector is at a value when the first partial similarity measurement is determined, in response to the partial similarity computation being bypassed, increment, with the first processing engine, the value of the index, and determine, with the first processing engine, whether to bypass a similarity computation of a third candidate vector based on a partial similarity measurement that is to be determined based on a feature value of the third candidate vector and a feature value of the query vector, wherein the feature value of the third candidate vector and the feature value of the query vector are both associated with the incremented value of the index.
Example 6 includes the computing system of any one of Examples 1 to 5, wherein the instructions, when executed, further cause the computing system to store the total similarity measurement and a plurality of similarity measurements in a max-heap binary tree or a min-heap binary tree, wherein the plurality of similarity measurements is to be determined based on different candidate vectors and the query vector, wherein the total similarity measurement is to be larger than each of the plurality of similarity measurements.
Example 7 includes the computing system of Example 1, the instructions, when executed, further cause the computing system to store a plurality of candidate vectors in a plurality of ping-pong buffers, determine, with the plurality of processing engines, a plurality of partial similarity measurements based on first portions of a plurality of query vectors and first portions of the plurality of candidate vectors, and determine, with the plurality of processing engines, that similarity computations associated with a first subset of the plurality of candidate vectors are to be bypassed based on a first subset of the plurality of partial similarity measurements and first total similarity measurements.
Example 8 includes the computing system of Example 7, the instructions, when executed, further cause the computing system to determine, with a group of the plurality of processing engines, that a second subset of the plurality of candidate vectors are to be processed based on a second subset of the plurality of partial similarity measurements and the first total similarity measurements, determine, with the group of the plurality of processing engines, second total similarity measurements based on the second subset of the plurality of candidate vectors and the plurality of query vectors, and store each respective total similarity measurement of the second total similarity measurements into different heap memories based on an identification of a query vector of the plurality of query vectors associated with the respective total similarity measurement, wherein each of the different heap memories is dedicated to one of the plurality of query vectors.
Example 9 includes a semiconductor apparatus comprising one or more substrates, and logic coupled to the one or more substrates, wherein the logic is implemented in one or more of configurable logic or fixed-functionality logic hardware, the logic coupled to the one or more substrates to determine, with a first processing engine of a plurality of processing engines, a first partial similarity measurement based on a first portion of a query vector and a first portion of a first candidate vector, determine, with a second processing engine of the plurality of processing engines, a total similarity measurement based on the query vector and a second candidate vector, and determine, with the first processing engine, whether to compare a second portion of the query vector to a second portion of the first candidate vector based on the first partial similarity measurement and the total similarity measurement.
Example 10 includes the apparatus of Example 9, wherein the logic coupled to the one or more substrates is to compare, with the first processing engine, the second portion of the query vector to the second portion of the first candidate vector in response to the first partial similarity measurement being less than the total similarity measurement, wherein the first partial similarity measurement is to be a partial distance and the total similarity measurement is to be a total distance.
Example 11 includes the apparatus of Example 9, wherein the logic coupled to the one or more substrates is to retrieve, with the plurality of processing engines, different candidate vectors, determine, with the plurality of processing engines, a plurality of partial similarity measurements between first portions of the query vector and first portions of the different candidate vectors, and determine, with the plurality of processing engines, whether to bypass partial similarity computations between second portions of the query vector and second portions of the different candidate vectors based on the plurality of partial similarity measurements and the total similarity measurement.
Example 12 includes the apparatus of Example 11, wherein the logic coupled to the one or more substrates is to access a plurality of memory storage areas that are each dedicated to one of the plurality of processing engines, wherein the plurality of memory storage areas is to store the different candidate vectors, wherein the different candidate vectors are to represent a vector candidate database.
Example 13 includes the apparatus of Example 9, wherein the logic coupled to the one or more substrates is to determine, with the first processing engine, to bypass a similarity computation of the first candidate vector based on the first partial similarity measurement and the total similarity measurement, wherein an index to the query vector is at a value when the first partial similarity measurement is determined, in response to the similarity computation of the first candidate vector being bypassed, increment, with the first processing engine, the value of the index, and determine, with the first processing engine, whether to bypass a similarity computation of a third candidate vector based on a partial similarity measurement that is to be determined based on a feature value of the third candidate vector and a feature value of the query vector, wherein the feature value of the third candidate vector and the feature value of the query vector are both associated with the incremented value of the index.
Example 14 includes the apparatus of any one of Examples 9 to 13, wherein the logic coupled to the one or more substrates is to store the total similarity measurement and a plurality of similarity measurements in a max-heap binary tree or a min-heap binary tree, wherein the plurality of similarity measurements is to be determined based on different candidate vectors and the query vector, wherein the total similarity measurement is to be larger than each of the plurality of similarity measurements.
Example 15 includes the apparatus of Example 9, wherein the logic coupled to the one or more substrates is to store a plurality of candidate vectors in a plurality of ping-pong buffers, determine, with the plurality of processing engines, a plurality of partial similarity measurements based on first portions of a plurality of query vectors and first portions of the plurality of candidate vectors, and determine, with the plurality of processing engines, that similarity computations associated with a first subset of the plurality of candidate vectors are to be bypassed based on a first subset of the plurality of partial similarity measurements and first total similarity measurements.
Example 16 includes the apparatus of Example 15, wherein the logic coupled to the one or more substrates is to determine, with a group of the plurality of processing engines, that a second subset of the plurality of candidate vectors are to be processed based on a second subset of the plurality of partial similarity measurements and the first total similarity measurements, determine, with the group of the plurality of processing engines, second total similarity measurements based on the second subset of the plurality of candidate vectors and the plurality of query vectors, and store each respective total similarity measurement of the second total similarity measurements into different heap memories based on an identification of a query vector of the plurality of query vectors associated with the respective total similarity measurement, wherein each of the different heap memories is dedicated to one of the plurality of query vectors.
Example 17 includes the apparatus of Example 9, wherein the logic coupled to the one or more substrates includes transistor channel regions that are positioned within the one or more substrates.
Example 18 includes at least one computer readable storage medium comprising a set of executable program instructions, which when executed by a computing system, cause the computing system to determine, with a first processing engine of a plurality of processing engines, a first partial similarity measurement based on a first portion of a query vector and a first portion of a first candidate vector, determine, with a second processing engine of the plurality of processing engines, a total similarity measurement based on the query vector and a second candidate vector, and determine, with the first processing engine, whether to compare a second portion of the query vector to a second portion of the first candidate vector based on the first partial similarity measurement and the total similarity measurement.
Example 19 includes the at least one computer readable storage medium of Example 18, wherein the instructions, when executed, further cause the computing system to compare, with the first processing engine, the second portion of the query vector to the second portion of the first candidate vector in response to the first partial similarity measurement being less than the total similarity measurement, wherein the first partial similarity measurement is to be a partial distance and the total similarity measurement is to be a total distance.
Example 20 includes the at least one computer readable storage medium of Example 18, wherein the instructions, when executed, further cause the computing system to retrieve, with the plurality of processing engines, different candidate vectors, determine, with the plurality of processing engines, a plurality of partial similarity measurements between first portions of the query vector and first portions of the different candidate vectors, and determine, with the plurality of processing engines, whether to bypass partial similarity computations between second portions of the query vector and second portions of the different candidate vectors based on the plurality of partial similarity measurements and the total similarity measurement.
Example 21 includes the at least one computer readable storage medium of Example 20, wherein the instructions, when executed, further cause the computing system to access a plurality of memory storage areas that are each dedicated to one of the plurality of processing engines, wherein the plurality of memory storage areas is to store the different candidate vectors, wherein the different candidate vectors are to represent a vector candidate database.
Example 22 includes the at least one computer readable storage medium of Example 18, wherein the instructions, when executed, further cause the computing system to determine, with the first processing engine, to bypass a partial similarity computation of the first candidate vector based on the first partial similarity measurement and the total similarity measurement, wherein an index to the query vector is at a value when the first partial similarity measurement is determined, in response to the partial similarity computation being bypassed, increment, with the first processing engine, the value of the index, and determine, with the first processing engine, whether to bypass a similarity computation of a third candidate vector based on a partial similarity measurement that is to be determined based on a feature value of the third candidate vector and a feature value of the query vector, wherein the feature value of the third candidate vector and the feature value of the query vector are both associated with the incremented value of the index.
Example 23 includes the at least one computer readable storage medium of any one of Examples 18 to 22, wherein the instructions, when executed, further cause the computing system to store the total similarity measurement and a plurality of similarity measurements in a max-heap binary tree or a min-heap binary tree, wherein the plurality of similarity measurements are to be determined based on different candidate vectors and the query vector, wherein the total similarity measurement is to be larger than each of the plurality of similarity measurements.
Example 24 includes the at least one computer readable storage medium of Example 18, wherein the instructions, when executed, further cause the computing system to store a plurality of candidate vectors in a plurality of ping-pong buffers, determine, with the plurality of processing engines, a plurality of partial similarity measurements based on first portions of a plurality of query vectors and first portions of the plurality of candidate vectors, and determine, with the plurality of processing engines, that similarity computations associated with a first subset of the plurality of candidate vectors is to be bypassed based on a first subset of the plurality of partial similarity measurements and first total similarity measurements.
Example 25 includes the at least one computer readable storage medium of Example 24, wherein the instructions, when executed, further cause the computing system to determine, with a group of the plurality of processing engines, that a second subset of the plurality of candidate vectors are to be processed based on a second subset of the plurality of partial similarity measurements and the first total similarity measurements, determine, with the group of the plurality of processing engines, second total similarity measurements based on the second subset of the plurality of candidate vectors and the plurality of query vectors, and store each respective total similarity measurement of the second total similarity measurements into different heap memories based on an identification of a query vector of the plurality of query vectors associated with the respective total similarity measurement, wherein each of the different heap memories is dedicated to one of the plurality of query vectors.
Example 26 includes a semiconductor apparatus comprising means for determining, with a first processing engine of a plurality of processing engines, a first partial similarity measurement based on a first portion of a query vector and a first portion of a first candidate vector, means for determining, with a second processing engine of the plurality of processing engines, a total similarity measurement based on the query vector and a second candidate vector, and means for determining, with the first processing engine, whether to compare a second portion of the query vector to a second portion of the first candidate vector based on the first partial similarity measurement and the total similarity measurement.
Example 27 includes the apparatus of Example 26, further comprising means for comparing, with the first processing engine, the second portion of the query vector to the second portion of the first candidate vector in response to the first partial similarity measurement being less than the total similarity measurement, wherein the first partial similarity measurement is to be a partial distance and the total similarity measurement is to be a total distance.
Example 28 includes the apparatus of Example 26, further comprising means for retrieving, with the plurality of processing engines, different candidate vectors, means for determine, with the plurality of processing engines, a plurality of partial similarity measurements between first portions of the query vector and first portions of the different candidate vectors, and means for determining, with the plurality of processing engines, whether to bypass partial similarity computations between second portions of the query vector and second portions of the different candidate vectors based on the plurality of partial similarity measurements and the total similarity measurement.
Example 29 includes the apparatus of Example 28, further comprising means for accessing a plurality of memory storage areas that are each dedicated to one of the plurality of processing engines, wherein the plurality of memory storage areas is to store the different candidate vectors, wherein the different candidate vectors are to represent a vector candidate database.
Example 30 includes the apparatus of Example 26, further comprising means for determining, with the first processing engine, to bypass a similarity computation of the first candidate vector based on the first partial similarity measurement and the total similarity measurement, wherein an index to the query vector is at a value when the first partial similarity measurement is determined, in response to the similarity computation of the first candidate vector being bypassed, means for incrementing, with the first processing engine, the value of the index, and means for determining, with the first processing engine, whether to bypass a similarity computation of a third candidate vector based on a partial similarity measurement that is to be determined based on a feature value of the third candidate vector and a feature value of the query vector, wherein the feature value of the third candidate vector and the feature value of the query vector are both associated with the incremented value of the index.
Example 31 includes the apparatus of any one of Example 26 to 30, further comprising means for storing the total similarity measurement and a plurality of similarity measurements in a max-heap binary tree or a min-heap binary tree, wherein the plurality of similarity measurements is to be determined based on different candidate vectors and the query vector, wherein the total similarity measurement is to be larger than each of the plurality of similarity measurements.
Example 32 includes the apparatus of Example 26, further comprising means for storing a plurality of candidate vectors in a plurality of ping-pong buffers, means for determining, with the plurality of processing engines, a plurality of partial similarity measurements based on first portions of a plurality of query vectors and first portions of the plurality of candidate vectors, and means for determining, with the plurality of processing engines, that similarity computations associated with a first subset of the plurality of candidate vectors are to be bypassed based on a first subset of the plurality of partial similarity measurements and first total similarity measurements.
Example 33 includes the apparatus of Example 32, further comprising means for determining, with a group of the plurality of processing engines, that a second subset of the plurality of candidate vectors are to be processed based on a second subset of the plurality of partial similarity measurements and the first total similarity measurements, means for determining, with the group of the plurality of processing engines, second total similarity measurements based on the second subset of the plurality of candidate vectors and the plurality of query vectors, and means for storing each respective total similarity measurement of the second total similarity measurements into different heap memories based on an identification of a query vector of the plurality of query vectors associated with the respective total similarity measurement, wherein each of the different heap memories is dedicated to one of the plurality of query vectors.

Thus, technology described herein may provide for an enhanced matching and query analysis that may efficiently retrieve results. Furthermore, the queries may be batch processes to facilitate low latency analysis. The embodiments described herein may also reduce memory footprints and latency as well as processing power.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a system-on-chip including a plurality of processing engines; and
a memory including a set of executable program instructions, which when executed by the system-on-chip, cause the computing system to perform operations comprising:
performing a plurality of distance calculations in parallel to determine a corresponding plurality of distance values indicating a similarity between a query vector and a corresponding plurality of candidate vectors;
performing a comparison of each distance value of the plurality of distance values with at least one threshold distance value;
pruning a first subset of the plurality of distance values based on the comparison; and
sorting a second subset of the plurality of distance values to generate an ordered set of nearest distance values.

2. The computing system of claim 1, wherein the set of executable program instructions are to cause the computing system to perform additional operations, comprising:
combining the plurality of distance values, or defined subsets thereof, to generate one or more similarity values indicating the similarity between the query vector and the corresponding plurality of candidate vectors.

3. The computing system of claim 2, wherein combining the plurality of distance values, or defined subsets thereof, comprises accumulating the plurality of distance values, or defined subsets thereof.

4. The computing system of claim 3, wherein pruning the first subset of the plurality of distance values based on the comparison comprises determining that at least one of the similarity values corresponding to the first subset is larger than the at least one threshold distance value.

5. The computing system of claim 2, wherein combining the plurality of distance values, or subsets thereof, comprises determining a cosine distance, a Euclidean distance, or an inner-product distance associated with the plurality of distance values, or subsets thereof.

6. The computing system of claim 1, wherein the set of executable program instructions are to cause the computing system to perform additional operations, comprising: partitioning a storage area in the memory to store the ordered set of nearest distance values.

7. The computing system of claim 1, wherein at least one processing engine of the plurality of processing engines comprises an artificial intelligence (AI) accelerator or a graphics processor coupled to the memory, the AI accelerator or graphics processor to execute the set of executable program instructions to perform the operations.

8. The computing system of claim 7, wherein at least one other processing engine of the plurality of processing engines comprises a host processor coupled to the memory.

9. A machine-readable medium having program code stored thereon which, when executed by one or more processing engines, is to cause the one or more processing engines to perform operations, comprising:
performing a plurality of distance calculations in parallel to determine a corresponding plurality of distance values indicating a similarity between a query vector and a corresponding plurality of candidate vectors;
performing a comparison of each distance value of the plurality of distance values with at least one threshold distance value;
pruning a first subset of the plurality of distance values based on the comparison; and
sorting a second subset of the plurality of distance values to generate an ordered set of nearest distance values.

10. The machine-readable medium of claim 9, wherein the set of executable program instructions are to cause the one or more processing engines to perform additional operations, comprising:
combining the plurality of distance values, or defined subsets thereof, to generate one or more similarity values indicating the similarity between the query vector and the corresponding plurality of candidate vectors.

11. The machine-readable medium of claim 10, wherein combining the plurality of distance values, or defined subsets thereof, comprises accumulating the plurality of distance values, or defined subsets thereof.

12. The machine-readable medium of claim 11, wherein pruning the first subset of the plurality of distance values based on the comparison comprises determining that at least one of the similarity values corresponding to the first subset is larger than the at least one threshold distance value.

13. The machine-readable medium of claim 10, wherein combining the plurality of distance values, or subsets thereof, comprises determining a cosine distance, a Euclidean distance, or an inner-product distance associated with the plurality of distance values, or subsets thereof.

14. The machine-readable medium of claim 12, wherein the set of executable program instructions are to cause the one or more processing engines to perform additional operations, comprising: partitioning a storage area in the memory to store the ordered set of nearest distance values.

15. The machine-readable medium of claim 12, wherein at least one processing engine of the plurality of processing engines comprises an artificial intelligence (AI) accelerator or a graphics processor coupled to the memory, the AI accelerator or graphics processor to execute the set of executable program instructions to perform the operations.

16. The machine-readable medium of claim 15, wherein at least one other processing engine of the plurality of processing engines comprises a host processor coupled to the memory.
